(19) United States
(12) Patent Application Publication
(10) Pub. No.: US 2006/0095435 A1
(43) Pub. Date: May 4, 2006

(54) Configuring and deploying portable application containers for improved utilization of server capacity

(75) Inventors: Christopher Johnson, Atlanta, GA (US); Joseph Daniel Kolar, Birmingham, AL (US); Suhas Talathi, Alpharetta, GA (US); Richard Bowman, Smyrna, GA (US); Dilip Tailor, Duluth, GA (US); James Michael Lockhart, Birmingham, AL (US)

Correspondence Address: MERCHANT & GOULD PC, P.O. BOX 2903, MINNEAPOLIS, MN, 55402-0903, US

(73) Assignee: BellSouth Intellectual Property Corporation

(21) Appl. No.: 11/255,494

(22) Filed: Oct. 21, 2005

Related U.S. Application Data
(60) Provisional application No. 60/621,557, filed on Oct. 22, 2004.

(51) Int. Cl. G06F 17/30

(52) U.S. Cl. 707/10

(57) ABSTRACT

Computer-implemented methods, configurations, computer program products and systems configure and deploy portable application containers (PACs) in a shared server environment. A method involves receiving metadata describing an application and receiving an instruction on what metadata to use in configuring the application where the application is associated with a PAC. The method also involves transforming the metadata into a list of commands in response to receiving the instruction and deploying the list of commands to a group of servers wherein the commands are operative to create the PAC. The PAC is a logical construct of the application configured to be logically separate from and to execute via any server in the group of servers. Each server in the group of servers can be used by multiple PACs to enable improved utilization of server capacity.

### RELATED APPLICATIONS

The present application claims priority from U.S. provisional application No. 60/621,557 entitled “Shared Platform Application Container Environment,” filed Oct. 22, 2004, said application incorporated herein by reference.

### TECHNICAL FIELD

The present invention is related to increasing utilization of server computer capacity. More particularly, the present invention is related to computer-implemented methods, configurations, systems, and computer program products for configuring and deploying portable application containers in a shared platform environment.

### BACKGROUND

Deploying an application, such as an internal business application, to a conventional standalone server can present challenges with low server capacity utilization, availability, deployment time, and high overall costs. High costs are usually associated with multiple and underutilized servers that have lengthy design and build cycles. Typically each deployment project acquires a server that is custom built by hand. Thus, numerous server designs, having one application with one server, lend themselves to very poor utilization. Consequently, as the number of discrete servers increases, costs can scale linearly without gaining any cost efficiencies. Also, inconsistencies in build techniques and software lead to increased support costs and operational challenges. And physical partitioning results in wasted compute capacity.

Typically, with conventional systems, the design and build process involves a requester contacting an administrator for the system and attempting to describe application requirements over the phone or over e-mail. The administrator attempts to design and build the application according to the request and may or may not get it right. For instance, there may have been some details left out thereby requiring the administrator get feedback from the requestor and potentially start over. Normally, the administrator figures out what is needed for each requested feature or requirement per request. The administrator then types appropriate commands on each requested server. The administrator may accidentally type a command differently or in a slightly different order on one server than he did another one. This activity could amount to hundreds of tasks for an administrator, having a tendency to being a very interactive kind of, non-repeatable, process.

Accordingly there is an unaddressed need in the industry to address the aforementioned and other deficiencies and inadequacies.

### SUMMARY

This Summary is provided to introduce a selection of concepts in simplified form that are further described below in the Detailed Description. This Summary is not intended to identify key features or essential features of the claimed subject matter, nor is the Summary intended for use as an aid in determining the scope of the claimed subject matter.

In accordance with embodiments of the present invention, methods, configurations, systems, and computer program products configure and deploy portable application container PACs in a shared platform application container environment. Embodiments of the present invention develop and implement a pre-provisioned, sustainable, and shared computing infrastructure that provides a standardized approach for efficiently deploying applications. The computing infrastructure is centrally managed and support shared. Embodiments of the present invention include application stacking models that facilitate an increase in overall infrastructure utilization and a reduction overall infrastructure costs and deployment time. The application stacking models are built for implementation with multiple architectures to keep them agnostic to any particular server technology.

One embodiment provides a computer-implemented method for configuring and deploying PACs in a shared server environment. The method involves receiving metadata describing an application and receiving an instruction on what metadata to use in configuring the application where the application is associated with a PAC. The method also involves transforming the metadata into a list of commands in response to receiving the instruction and deploying the list of commands to a group of servers wherein the commands are operative to create the PAC. The PAC is a logical construct of the application configured to be logically separate from and to execute via any server in the group of servers. Each server in the group of servers can be used by multiple PACs to enable improved utilization of server capacity.

Another embodiment is a deployment engine including a computer-readable medium having control logic stored therein for causing a computer to configure and deploy PACs to a group of servers (PODs). The deployment engine includes a layered POD library having computer-readable program code for causing the computer to abstract a POD storage configuration and provide functions to access sections of the POD storage configuration. The deployment engine also includes a layered PAC library having computer-readable program code for causing the computer to abstract a PAC storage configuration and provide functions to access sections of the PAC storage configuration. Still further, the deployment engine includes a layered consolidated infrastructure software stack (CISS) library having computer-readable program code for causing the computer to abstract a CISS storage configuration and provide functions to access sections of the CISS storage configuration. There is a different CISS library for each type of server.

Still further, another embodiment is a computer-implemented system for configuring and deploying a PAC. The system includes a repository operative to receive metadata describing an application and a deployment engine operative to receive an instruction on what metadata to use in configuring the application where the application is a PAC. The deployment engine is also operative to retrieve the metadata from the repository and generate a list of commands based on the metadata in response to receiving the instruction. Additionally, the deployment engine is operative to deploy the list of commands to a logical group of servers where the commands are operative to create the PAC. The PAC is a logical construct of the application configured to be logically separate from and to execute via any server in the logical group of servers.

Aspects of the invention may be implemented as a computer process, configuration, a computing system, or as an article of manufacture such as a computer program product or computer-readable medium. The computer program product may be a computer storage media readable by a computer system and encoding a computer program of instructions for executing a computer process. The computer program product may also be a propagated signal on a carrier readable by a computing system and encoding a computer program of instructions for executing a computer process.

Other configurations, computer program products, methods, features, systems, and advantages of the present invention will be or become apparent to one with skill in the art upon examination of the following drawings and detailed description. It is intended that all such additional configurations, methods, systems, features, and advantages be included within this description, be within the scope of the present invention, and be protected by the accompanying claims.

### BRIEF DESCRIPTION OF THE DRAWINGS

FIG. 1 is a schematic diagram illustrating aspects of a control center server, a PAC requirements package, and a shared platform application container networked environment utilized in an illustrative embodiment of the invention;

FIG. 2 illustrates a PAC requirements package web interface and corresponding repository metadata according to an illustrative embodiment of the invention;

FIG. 3 illustrates computing system architecture for the control center server of FIG. 1 utilized in an illustrative embodiment of the invention;

FIG. 4 is a schematic diagram illustrating aspects of a deployment engine transforming metadata into lists of commands according to an illustrative embodiment of the invention;

FIG. 5 is a schematic diagram illustrating aspects of a control center server creating a PAC by deploying the list of commands to a target server in a POD according to an illustrative embodiment of the invention;

FIG. 6 is a schematic diagram illustrating aspects of PAC and POD configurations in the shared platform application environment according to an illustrative embodiment of the invention; and

FIG. 7 illustrates an operational flow performed in configuring and deploying a PAC according to an illustrative embodiment of the invention.

### DETAILED DESCRIPTION

As described briefly above, embodiments of the present invention provide methods, configurations, systems, and computer-readable mediums for configuring and deploying a PAC in a shared platform application environment (SPACE). In the following detailed description, references are made to accompanying drawings that form a part hereof, and in which are shown by way of illustration specific embodiments or examples. These illustrative embodiments may be combined, other embodiments may be utilized, and structural changes may be made without departing from the spirit and scope of the present invention. The following detailed description is, therefore, not to be taken in a limiting sense, and the scope of the present invention is defined by the appended claims and their equivalents.

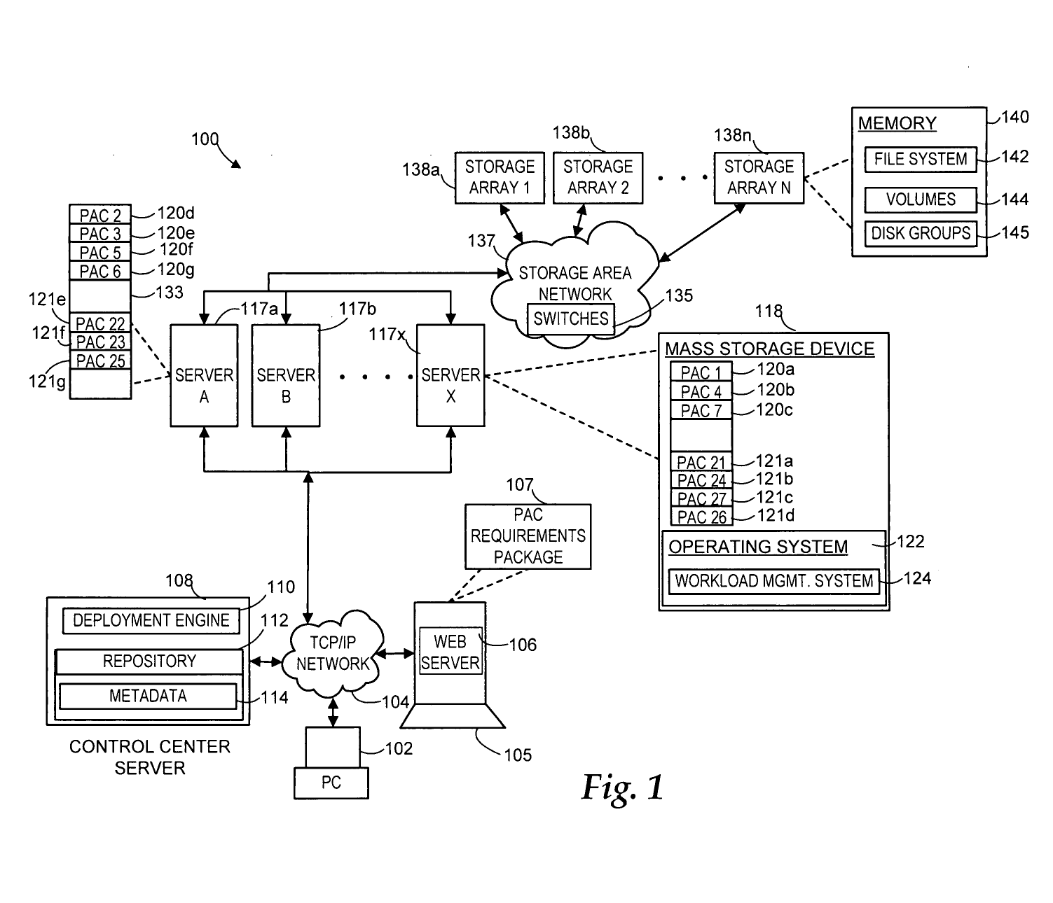

Referring now to the drawings, in which like numerals represent like elements through the several figures, aspects of the present invention and the illustrative operating environment will be described. FIGS. 1-3, 5, and 6 and the following discussion are intended to provide a brief, general description of a suitable computing environment in which the embodiments of the invention may be implemented. While the invention will be described in the general context of program modules that execute in conjunction with firmware that executes on a computing apparatus, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 1, a schematic diagram illustrating aspects of a control center server 108, a PAC requirements package 107, and a shared platform application container environment 100 utilized in an illustrative embodiment of the invention will be described. As shown in FIG. 1, the networked environment 100 includes a PAC requirements server 105 housing a web server application 106 and the PAC requirements package 107. The PAC requirements package 107 is a web interface utilized to input specific requirements for an application, referred to as the PAC, over a network 104 via a remote computing apparatus, such as a personal computer (PC) 102.

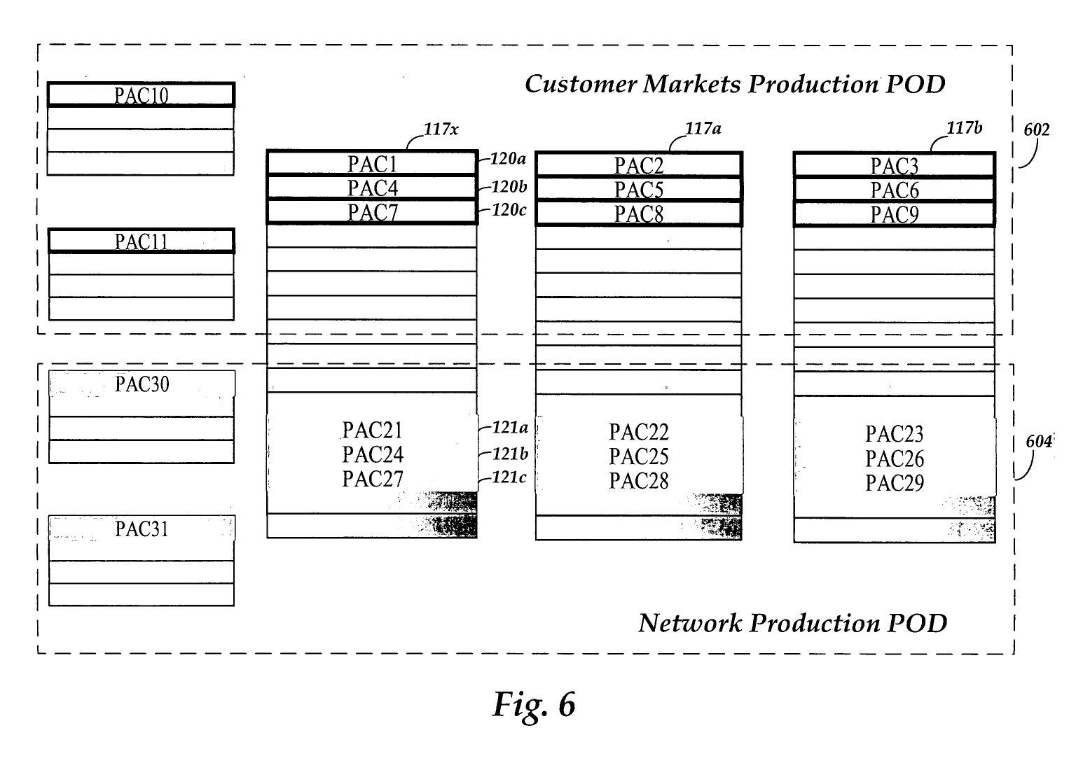

The networked environment 100 also includes the control center server 108 housing, among other components, a deployment engine 110 and a repository 112 which houses metadata 114 received via the PAC requirements package 107 and transferred over the network 104. The metadata defines the PAC for deployment based on inputs received via the PAC requirements package. Additionally, the networked environment 100 includes multiple servers, for instance servers 117a-117x forming a logical group of servers, also referred to as a POD or multiple PODs, to be utilized by PACs deployed over the network 104. The servers 117a-117x include multiple PACs, for instance PACs 120a-121c and PACs 121a-121d stored on a mass storage device (MSD) 118. The servers 117a-117x can also be a part of more than one POD. For example, the PACs 120a-120c on the server 117x and PACs 120d-120g on the server 117a can be part of the one POD while the PACs 121a-121d and PACs 121e-121f are part of a different POD. Additional details regarding multiple PODs will be described below with respect to FIG. 6.

The MSD 118 also includes an operating system 122 housing a workload management system 124. Each PAC utilizing the server 117x is associated with the operating system 122. If one of the PACs 120 or 121 tries to consume all the resources associated with a POD, the workload management system 124 is a configuration that keeps a PAC from totally overwhelming the other applications or PACs while ensuring that the PAC trying to consume still has some amount of resources to operate. The servers 117a-117x are in communication with storage arrays 138a-138n over a storage area network 137 including switches 135. The storage arrays, for instance the storage array 138n includes a memory 140 storing data in the form of a file system 142, volumes 144, and/or disk groups 145. This data and binaries make up or are part of a PAC. Configuration components that define the data and the binaries reside logically in the configuration repository 112. This configuration is deployed across all servers.

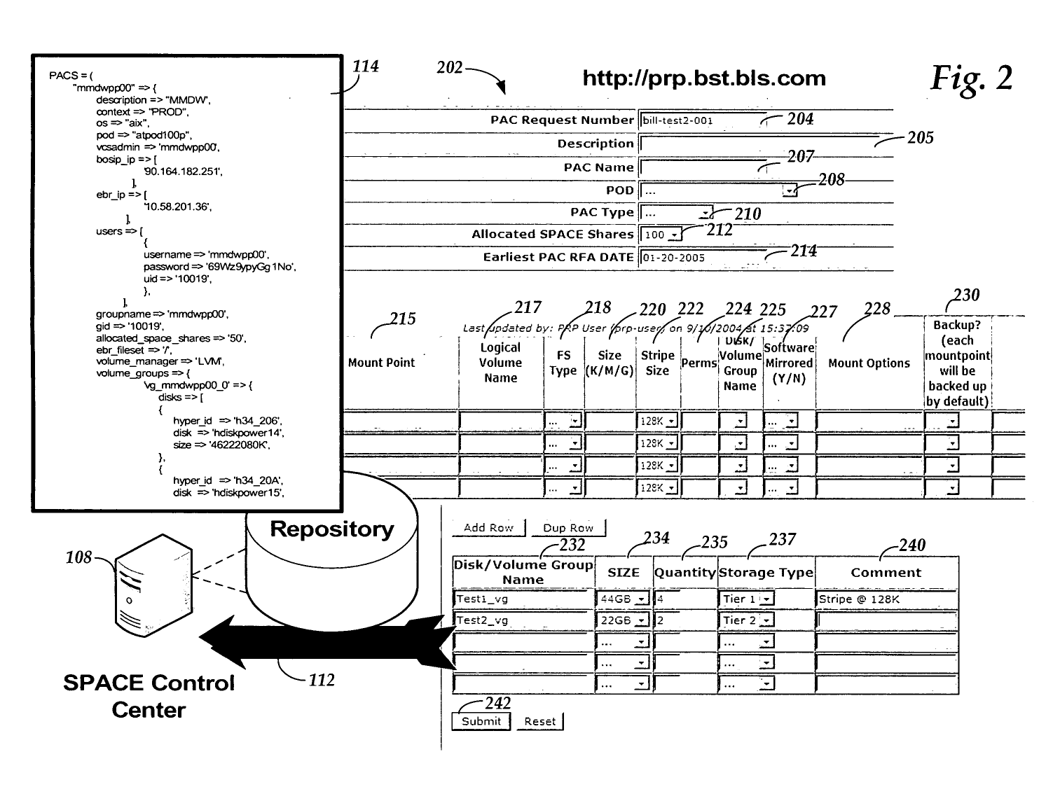

Thus, the data provides a portable piece associated with a PAC because the data is not tied to any hardware component and does not physically reside on any server. However, any of the servers 117a-117n can attach to or access the data on the storage arrays 138a-138n via the storage area network 137. The logical configuration of each PAC, including data components residing on the memory 140, is defined by the metadata 114 residing in the repository 112. The deployment engine 110 transforms the metadata 114 into a list of commands that instructs the servers on where the disk groups 145, the volumes 144, and file systems 142 are. The list of commands also instructs the servers 117a-117x on necessary addresses to locate the data, what users are involved, what to monitor out of a monitoring system, and back-up information. Additional details regarding the control center server 108 and the deployment engine 110 will be described below with respect to FIGS. 2-5.

FIG. 2 illustrates a PAC requirements package (PRP) web interface 202 and corresponding metadata 114 residing in the repository 112 of the control center server 108 according to an illustrative embodiment of the invention. The PRP interface 202 helps a requestor know exactly what to request and ensures a repeatable process. Thus, when a requestor wants build an exact same configuration at a different data center the metadata is already available. The requestor can enter data to build, for example, a web server PAC or a database PAC. The data captured via the PRP interface 202 is forwarded to the configuration repository 112. The PRP interface 202 includes a variety of fields for generating corresponding metadata. The fields include a request number field 204, a description field 205, a PAC name field 207, a POD selection field, and a PAC type field 210. The PRP interface 202 evaluates a PAC name in the PAC name field 207 based on naming standards. For instance, naming standards for a PAC database based on ORACLE naming standards would include the following:

PACName
<[A]AAA><R><L><NN>
-<[A]AAA> Application Name

•[A] - Data Center Location.
•<[A]AAA> Meaning Full Application Arb-<R> - Application
Life-Cycle Role
•P=Prod; D=Dev; Q=QA; T=Test; U=UAT etc

-<L> - P=Primary; S=Secondary Site
-<NN> - 01-99 Instances

Similarly, POD names are a preinstalled infrastructure. The PRP interface 202 actually checks naming conventions. Thus, some of the fields the PRP interface 202 will not allow the use of entries that are invalid. The PAC type is also a preinstalled infrastructure. The PAC type field 210 can include a web server, a database, an application server, or even a custom designed type. Some components are foundational and are common to all PAC types. For instance, an ORACLE database or web server will both need an IP address. Other fields include an allocated shares field 212 and an earliest PAC completion date field 214. Allocated shares are part of a workload management profile. This is where a request is made for a minimum amount of resources. For instance, if a requester estimated that two CPUs and four gigabytes of RAM are needed to run a web server effectively, the allocated shares field 212 is where such request is made.

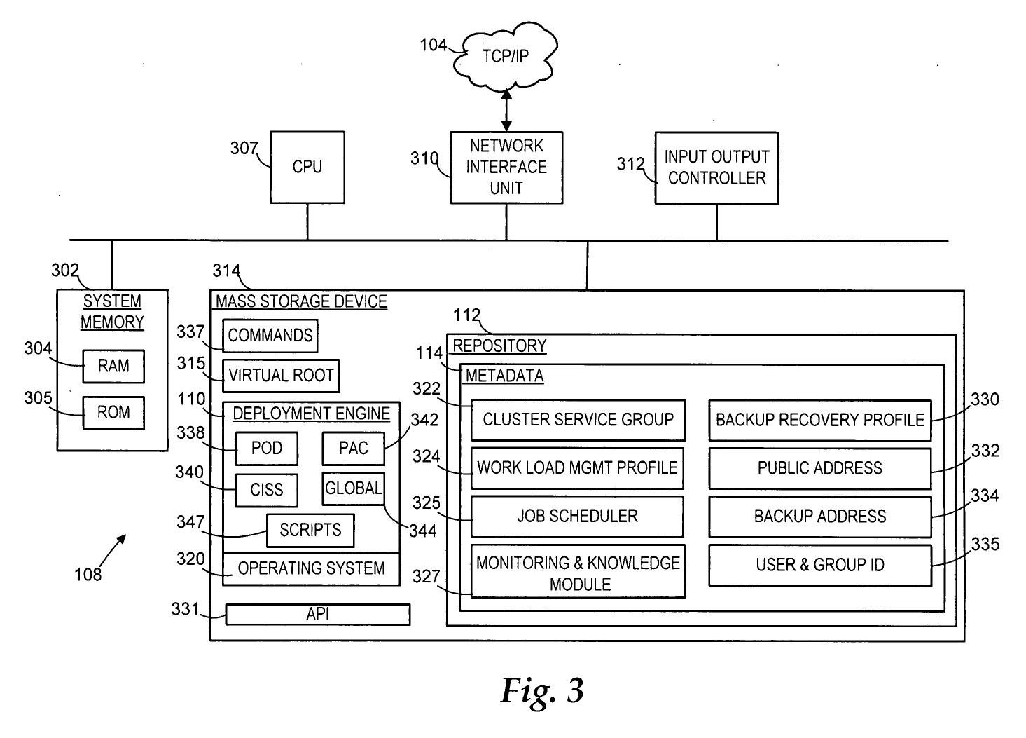

Other fields include a mount point field 215, a logical volume name field 217, a file system (FS) type field 218, and a size field 220. Other fields are a stripe size field 222, a perms field 224, a disk volume group name indicator field 225, a software mirrored field 227, a mount options field 228, and a backup field 230. Still further, the PRP interface 202 includes, a disk volume group name field 232, a lun size field 234, a quantity field 235, a storage type field 237 and a comment field 240. Once, the entries are input into the PRP interface 202, a selection of a submit button 242 sends a PRP to a review state. During the review state, one or more reviewers examine the entries to make sure that there is enough capacity, all entry criteria are met, and that the dates can be met. The PRP is then sent to finalize status where all of the data in the PRP forwarded to and stored in the repository 112. The PRP also generates requests in other sub systems via APIs associated with the subsystems. For instance, the PRP generates a request to create a back up job. Additional details regarding the use of metadata received via the PRP interface 202 will be described below with respect to FIGS. 3-5.

Referring now to FIGS. 1-3, computing system architecture for the control center server (CCS) 108 of FIG. 1, utilized in an illustrative embodiment of the invention, will be described. The CCS server 108 includes a central processing unit (CPU) 307, a system memory 302, and a system bus 309 that couples the system memory 302 to the CPU 307. The system memory 302 includes read-only memory (ROM) 305 and random access memory (RAM) 304. A basic input/output system (BIOS) (not shown), containing the basic routines that help to transfer information between elements within the CCS server 108, such as during start-up, is stored in ROM 305. The CCS server 108 further includes a mass storage device (MSD) 314 for storing an operating system 320 such as WINDOWS XP, from MICROSOFT CORPORATION of Redmond, Wash., the deployment engine (DE) 110 for configuring and deploying PACs, the repository 112 housing the metadata 114, a list of commands 337 for deployment to a POD, and a virtual root 315 for recording and updating the list of commands. An API 331 is included to assist in communication between the PRP server 105 and the CCA 108. Also, an input controller 312 may also be included for receiving and processing input from a number of input devices, including a keyboard, audio and/or voice input, a stylus and/or mouse (not shown).

The DE 110 includes a layered POD library 338, for example PODS.inc, operative to cause the CCS 108 to abstract a POD storage configuration and provide functions to access sections of the POD storage configuration and a layered PAC library, PACS.inc, 342 operative to cause the CCS 108 to abstract a storage PAC configuration and provide functions to access sections of the PAC storage configuration. The DE 110 also includes a layered consolidated infrastructure software stack (CISS) library 340, CISS.inc, operative to cause the CCS 108 to abstract a CISS storage configuration and provide functions to access sections of the CISS storage configuration. There is a different CISS library 340 for each type of server in the POD. Still further, the DE 110 includes a layered global library, Global.inc, operative to cause the CCS 108 to abstract a shared global configuration and provide functions in support of creating pathnames, configuration locking, time stamps, an IP address pool, a user ID (UID) pool, a group ID (GID) pool, and/or eTrust connectivity.

The DE 110 also includes core scripts or functions 347 that are called to use or view configurations in libraries. Although the CISS library 340 has a different infrastructure stack library for each type of server, the DE 110 will run the commands appropriate for that CISS. The PACs are created in the same pattern, but the tasks necessary for PAC creation vary according to the operating system and storage technology in the POD. The core script, “Ciss_manage.pl” can be used by outside programs to use or view CISS configurations and for SPACE administrators to manage CISS configurations.

### EXAMPLE

ciss_manage.pl-l to list all CISS

Similarly, the core script “pod-manage.pl” can be used by outside programs to use or view POD configurations and for SPACE admins to manage POD configurations.

### EXAMPLES

pod_manage.pl-sync <podname>

pod-manage.pl-l <podname>

Still further, the core script “pac_manage.pl” can be used by outside programs to use or view PAC configurations and for SPACE admins to manage PAC configurations.

### EXAMPLES

pac_manage.pl-create <podname>

pac_manage.pl-l <podname>

Because access by outside SPACE scripts rely on the functions in the POD library 238, the PAC library 342, and the CISS library 340, the method of storing the configuration can be easily modified in the future. For example, the current flat file structure for storing the SPACE configuration could be converted into a relational database schema.

### Example Functions

| | |
|---|---|
| pod_get_os(<podname); | pod_get_bosip_nic(<podname>); |

| pod_get_bosip_ip(<podname>); | |
|---|---|
| pod_get_hotel(<podname>); pod_get_nodes(<podname>); | |
| pod_create(<podname>,<bosip nic>, ...> | |
| pac_get_pod(<pacname); | pac_get_users(<pacname>); |

pac_get_groups(<pacname>);
pac_get_vol_grps(<pacname>);
pac_create(<pacname>,<bosip nic>, ...>
ciss_get_os(<cissname>);
ciss_get_applications(<cissname>);
ciss_get_os_patchlevel(<cissname>);
ciss_create(<name>,<os>, ...>

The DE 110 utilizes the libraries and the metadata 114 to create and run the commands 337 and to create and push the virtual root 315 to the POD.

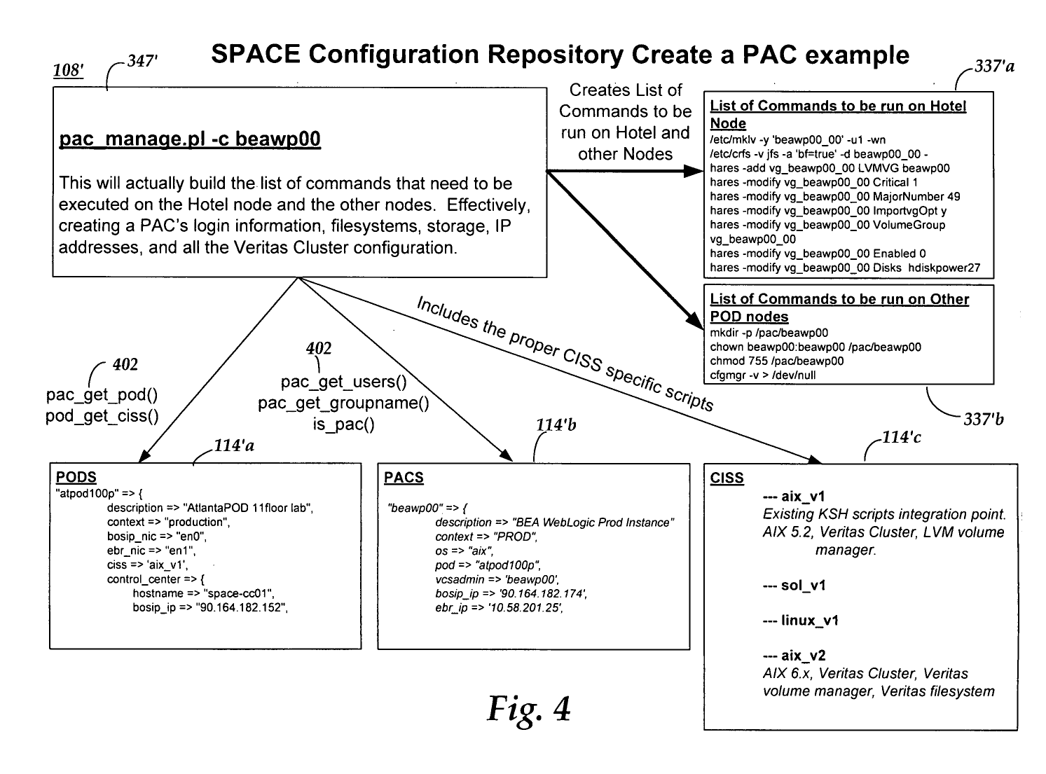

The MSD 314 also includes the repository 112 housing the metadata 114 received from the PRP server 105. The metadata 114 includes a cluster service group 322, a workload management profile 324 defining the workload management system 124 (FIG. 1), a job scheduler 325 describing a PAC schedule, and a monitoring and knowledge module 327 containing metadata describing the configuration of monitor and knowledge system associated with a PAC. The metadata also includes a backup recovery profile 330, a public TCP address 332, a backup TCP address 334, and a user and group identifier 335. Additional details regarding configuring and deploying PACs will be described below with respect to FIGS. 4-7.

It should be appreciated that the MSD 314 may be a redundant array of inexpensive discs (RAID) system for storing data. The MSD 314 is connected to the CPU 307 through a mass storage controller (not shown) connected to the system bus 309. The MSD 314 and its associated computer-readable media, provide non-volatile storage for the CCS 108. Although the description of computer-readable media contained herein refers to a mass storage device, such as a hard disk or RAID array, it should be appreciated by those skilled in the art that computer-readable media can be any available media that can be accessed by the CPU 307.

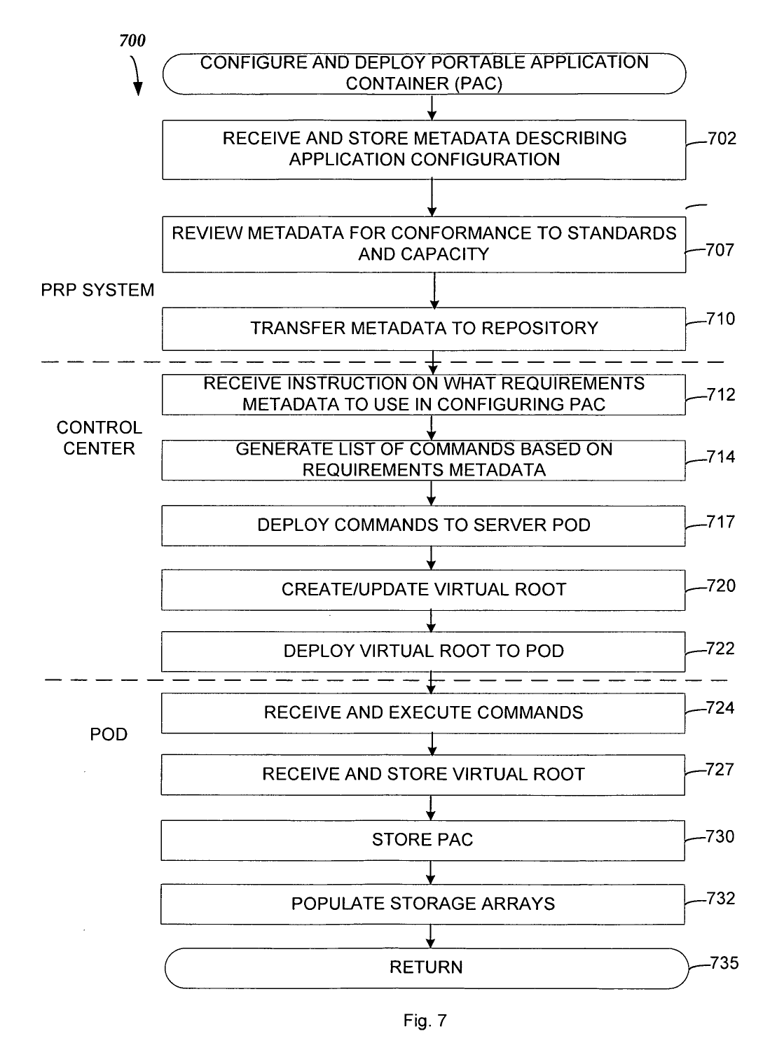

The CPU 307 may employ various operations, discussed in more detail below with reference to FIG. 7 to provide and utilize the signals propagated between the CCS 108 and the servers 117a-117x (FIG. 1). The CPU 307 may store data to and access data from MSD 314. Data is transferred to and received from the storage device 314 through the system bus 309. The CPU 307 may be a general-purpose computer processor. Furthermore as mentioned below, the CPU 307, in addition to being a general-purpose programmable processor, may be firmware, hard-wired logic, analog circuitry, other special purpose circuitry, or any combination thereof.

According to various embodiments of the invention, the CCS 108 operates in a networked environment, as shown in FIG. 1, using logical connections to remote computing devices via network communication, such as an Intranet, or a local area network (LAN). The CCS 108 may connect to the network 104 via a network interface unit 310. It should be appreciated that the network interface unit 310 may also be utilized to connect to other types of networks and remote computer systems.

A computing system, such as the CCS 108, typically includes at least some form of computer-readable media. Computer readable media can be any available media that can be accessed by the CCS 108. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, disk drives, a collection of disk drives, flash memory, other memory technology or any other medium that can be used to store the desired information and that can be accessed by the central server 104.

Communication media typically emibodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

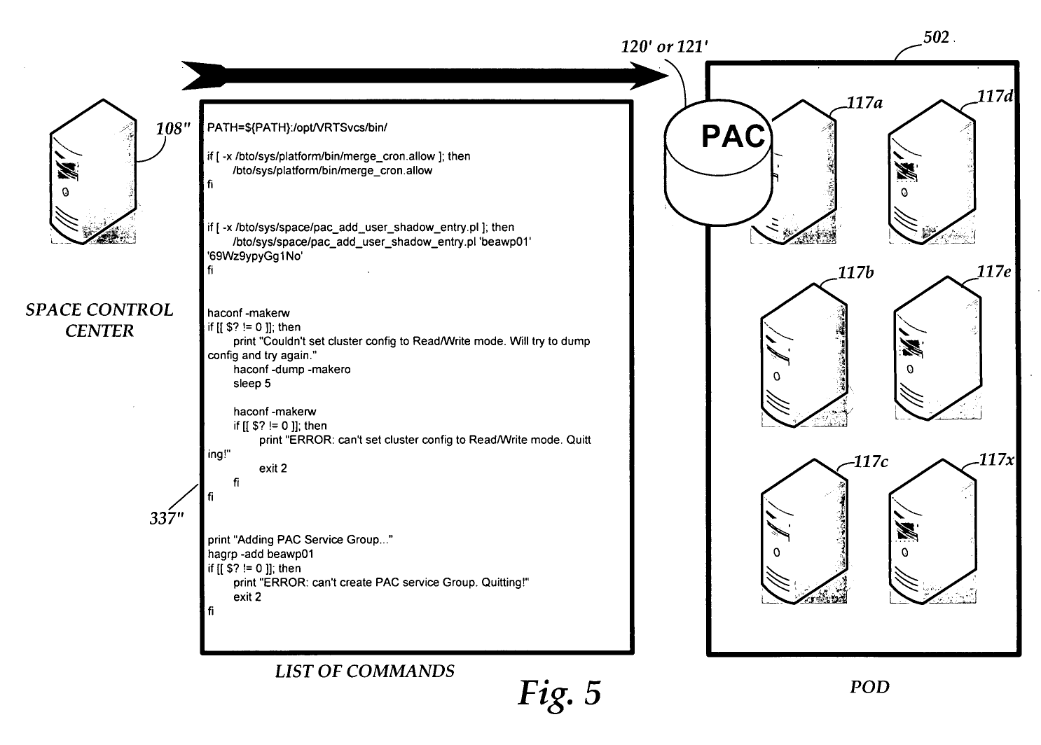

FIG. 4 is a schematic diagram illustrating aspects of a deployment engine transforming metadata 114′ into lists of commands 337′ according to an illustrative embodiment of the invention. The core script 347′ uses the library functions 402 to transform the metadata 114′a, 114′b, and 114′c into the lists of commands 337′a and 337′b. For instance, an advanced interactive executive (AIX) server will query the a CISS script to determine node information for a cluster, such as IP, routes, operating system version, and packages to install. An Enterprise Resource Planning (ERP) application or other software tool can use a SOAP::XML interface to expedite the creation of new PACs and to query existing PAC configurations. Additional details regarding the creation of PACs will be described below with respect to FIGS. 5-7.

FIG. 5 is a schematic diagram illustrating aspects of a CCS 108″ creating a PAC 120′ or 121′ by deploying the list of commands 337″ to a target server 117a in a POD 502 according to an illustrative embodiment of the invention. The CCS 108″ generates the list of commands 337″, runs the commands and forwards the list to the target server 117a to create the PAC 120′. The POD 502 includes at least a portion of the servers 117a-117x. The list of commands 337″ is a subset of a PAC build.

FIG. 6 is a schematic diagram illustrating aspects of PACs 120a-120c and 121a-121c configurations and PODs 602 and 604 configurations in the shared platform application environment according to an illustrative embodiment of the invention. Multiple PACs 120a-120c are configured to execute via the server 117x. However, the PACs 120a-120c can also execute via any server in the POD 602 configured for customer markets. Similarly, the PACs 121a-121c are configured to execute via any server in the POD 604 configured for network production.

FIG. 7 illustrates an operational flow 700 performed in configuring and deploying a PAC according to an illustrative embodiment of the invention. The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system or apparatus implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

Referring now to FIGS. 1, 2, and 7, the operational flow 700 begins at operation 702 where the PRP interface 202 receives metadata via the PC 102 describing an application configuration to create and store the PRP 107. Next at operation 707 the PRP system 105 reviews the metadata entries for conformance to standards and for sufficient capacity.

Next at operation 710 the PRP system 105 transfers the metadata 114 to the repository 112 of the CCS 108. Then at operation 712, the DE 110 receives an instruction on what metadata to use in configuring a PAC. The operational flow 700 then continues to operation 714.

At operation 714, the DE 110 transforms the metadata 114 into a list of commands 337. As described above, with respect to FIG. 3, the DE 110 abstracts the libraries to generate the list of commands based on the metadata 114. Then at operation 717 the DE 110 deploys the list of commands to the server POD. The commands 337 are operative to create a PAC.

At operation 720, the DE 110 creates or updates the virtual root 315 based on the list of commands. The DE 110 then deploys the virtual root 315 to the POD at operation 722.

Next, at operation 724, the POD receives and executes the commands to initiate creation of the PAC. At operation 727, the POD also receives and stores the virtual root 315 for backup or update purposes. Then at operation 730, the POD stores the configured PAC on a target server in the POD. Then the operational flow 700 continues to operation 732. At operation 732, the commands 337 populate the storage arrays 138 via the POD. Next, control returns to other routines at return operation 735.

Thus, the present invention is presently embodied as methods, systems, apparatuses, computer program products or computer readable mediums encoding computer programs for configuring and deploying PACs for improved server capacity utilization.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A computer-implemented method for configuring and deploying a portable application container, the method comprising:
receiving metadata describing an application;
receiving an instruction on what metadata to use in configuring the application wherein the application comprises a portable application container;
in response to receiving the instruction, generating a list of commands based on the metadata; and
deploying the list of commands to a logical group of servers wherein the commands are operative to create the portable application container;
wherein the portable application container comprises a logical construct of the application configured to be logically separate from and to execute via any server in the logical group of servers; and
wherein each server in the group of logical servers can be used by a plurality of portable application containers thereby enabling improved utilization of server capacity.

2. The method of claim 1, wherein receiving the metadata comprises receiving the metadata into a repository further comprising prior to receiving the metadata into the repository:
receiving the metadata via a web interface;
reviewing the metadata for conformance standards; and
in response to the metadata meeting conformance standards, transferring the metadata to the repository.

3. The method of claim 2, wherein receiving the metadata via a web interface comprises receiving at least one of the following:
a description of the portable application container;
a name of the portable application container;
a logical group of servers selection;
a type of PAC;
allocated shares for the PAC to determine correlated hardware;
a logical volume name and size; and
a disk/volume group name, size, and quantity.

4. The method of claim 2, wherein reviewing the metadata comprises at least one of the following:
correlating the metadata to one or more central processing unit resources and memory resources; and
ensuring that the metadata complies with naming standards to avoid use of the same name twice.

5. The method of claim 1, further comprising:
receiving the list of commands and executing the commands;
creating the portable application container in response to executing the commands; and
populating one or more storage arrays with at least one of data or binaries defined by the metadata and associated with the portable application container wherein the data and binaries comprise at least one of file systems, volumes, or disk groups that are accessible to any server in the logical group of servers.

6. The method of claim 5, wherein receiving the metadata comprises receiving configuration components that inform the logical group of servers where the data or binaries are located in the storage arrays and wherein the configuration components comprise at least one of the following:
a cluster service group;
a workload management profile;
a job scheduler;
a monitoring module;
a knowledge module;
a backup recovery profile;
a public TCP/IP address;
a backup TCP/IP address;
a user identifier; and
a group identifier.

7. The method of claim 1, wherein generating a list of commands based on the metadata comprises calling one or more core scripts to transform the metadata into the list of commands therein creating at least one of the following for the portable application container:
login information;
file systems;
storage;
IP addresses; and
a cluster configuration.

8. The method of claim 7, wherein calling one or more core scripts to transform the metadata into the list of commands comprises at least one of the following:
abstracting a storage configuration for the logical group of servers and providing functions to access sections of the storage configuration for the logical group of servers;
abstracting a storage configuration for the PAC and providing functions to access sections of the storage configuration for the PAC;
abstracting a storage configuration for a consolidated infrastructure software stack and providing functions to access sections of the storage configuration for the consolidated infrastructure software stack; and
abstracting a shared global configuration and providing functions in support of creating at least one of pathnames, configuration locking, time stamps, an IP address pool, a UID pool, a GID pool, or eTrust connectivity.

9. A deployment engine comprising a computer-readable medium having control logic stored therein for causing a computer to configure and deploy portable application containers (PACs) to a group of servers (POD), the deployment engine comprising at least one of the following:
a layered POD library comprising computer-readable program code for causing a computer to abstract a storage configuration for the POD and provide functions to access sections of the storage configuration for the POD;
a layered PAC library comprising computer-readable program code for causing the computer to abstract a storage configuration for the PAC and provide functions to access sections of the storage configuration for the PAC; and
a layered consolidated infrastructure software stack (CISS) library comprising computer-readable program code for causing the computer to abstract a storage configuration for a CISS and provide functions to access sections of the storage configuration for the CISS wherein there is a different CISS library for each type of server in the POD.

10. The deployment engine of claim 9, further comprising a layered global library comprising computer-readable program code for causing the computer to abstract a shared global configuration and provide functions in support of creating at least one of pathnames, configuration locking, time stamps, an IP address pool, a UID pool, a GID pool, or eTrust connectivity.

11. The deployment engine of claim 9, wherein the computer readable program code for causing the computer to configure and deploy one or more PACs comprises computer-readable program code for causing the computer to:
receive metadata describing an application;
receive an instruction on what metadata to use in configuring the application wherein the application comprises a PAC;
in response to receiving the instruction, transform the metadata into a list of commands; and
deploy the list of commands to the POD wherein the commands are operative to create the PAC;
wherein the PAC comprises a logical construct of the application configured to be logically separate from and to execute via any server in the POD; and
wherein each server in the POD can be used by a plurality of PACs thereby enabling improved utilization of server capacity.

12. The deployment engine of claim 11, wherein the computer-readable program code for causing the computer to transform the metadata into a list of commands comprises computer-readable program code for causing the computer to call one or more core functions to transform the metadata into the list of commands therein creating at least one of the following for the PAC:
login information;
file systems;
storage;
IP addresses; and
a cluster configuration.

13. The deployment engine of claim 12, wherein the computer-readable program code for causing the computer to transform the metadata into a list of commands comprises computer-readable program code for causing the computer to, in response to calling the core functions, abstract a storage configuration for at least one of the POD, the PAC, or the CISS and provide functions to access sections of the storage configuration for at least one of the POD, the PAC, or the CISS.

14. A computer-implemented system for configuring and deploying a portable application container (PAC), the system comprising:
a repository operative to receive metadata describing an application; and
a deployment engine operative to:
receive an instruction on what metadata to use in configuring the application wherein the application comprises a PAC;
in response to receiving the instruction, retrieve the metadata from the repository and generate a list of commands based on the metadata; and
deploy the list of commands to a logical group of servers wherein the commands are operative to create the PAC;
wherein the PAC comprises a logical construct of the application configured to be logically separate from and to execute via any server in the logical group of servers.

15. The system of claim 14 further comprising the logical group of servers wherein each server in the group of logical servers can be used by a plurality of PACs thereby enabling improved utilization of server capacity and wherein at least one server within the logical group of servers is operative to:
receive the list of commands and executing the commands;
create the PAC in response to executing the commands; and
populate one or more storage arrays with at least one of data or binaries defined by the metadata and associated with the PAC wherein the data and binaries comprise at least one of file systems, volumes, or disk groups that are accessible to any server in the logical group of servers.

16. The system of claim 15, wherein the deployment engine operative to retrieve the metadata is operative to receive configuration components that inform the logical group of servers where the data or binaries are located in the storage arrays and wherein the configuration components comprise at least one of the following:
a cluster service group;
a workload management profile;
a job scheduler;
a monitoring module;
a knowledge module;
a backup recovery profile;
a public TCP/IP address;
a backup TCP/IP address;
a user identifier; and
a group identifier.

17. The system of claim 14, wherein the deployment engine is further operative to:
generate or update a virtual root operative to receive a copy of the list of commands; and
copy the virtual root to each server in the group of servers.

18. The system of claim 17, further comprising the virtual root operative to update the list of commands on the group of servers.

19. The system of claim 14, further comprising a PAC requirements package server operative to:
receive the metadata via a web interface comprising a PAC requirements package;
receive a review the metadata for conformance standards; and
in response to the metadata meeting conformance standards, transfer the metadata to the repository.

20. The system of claim 19, wherein receiving the metadata via the PAC requirements package comprises receiving at least one of the following:
a description of the portable application container;
a name of the portable application container;
a logical group of servers selection;
a type of PAC;
allocated shares for the PAC to determine correlated hardware;
a logical volume name and size; and
a disk/volume group name, size, and quantity.
